(19) United States
(12) Patent Application Publication
(10) Pub. No.: US 2025/0244504 A1
(43) Pub. Date: Jul. 31, 2025

(54) MEASURING SYSTEM AND FLOOD WARNING METHOD

(71) Applicant: Endress+Hauser SE+Co. KG, Maulburg (DE)

(72) Inventors: Eric Birgel, Schopfheim (DE); Florian Falger, Häg-Ehrsberg (DE); Clemens Haberstroh, Lenzkirch (DE); Janina Meng, Lörrach (DE); Benjamin Mewes, Bochum (DE); Henning Oppel, Bochum (DE); Cornelius Jantschke, Stuttgart (DE)

(21) Appl. No.: 18/862,731

(22) PCT Filed: Apr. 28, 2023
(86) PCT No.: PCT/EP2023/061362

§ 371 Date: Nov. 4, 2024

(30) Foreign Application Priority Data
May 4, 2022 (DE) 10 2022 111 049.4

(51) Int. Cl. G01W 1/10; G01W 1/14; G06N 3/02

(52) U.S. Cl. CPC G01W 1/10; G01W 1/14; G06N 3/02

(57) ABSTRACT

A measuring system and method are provided for forecasting a region reaction at defined target locations in a drainage basin of water. At least the water level, the soil moisture, and/or a possible precipitation are measured using corresponding measuring devices at meaningful sites of the drainage basin. Based on such measured values, the region reaction, i.e., a flow rate and/or a water level, is forecast using a decentral evaluation unit for the target locations in the relevant time period. In the evaluation unit is a self learning algorithm based on artificial intelligence for producing the relationship between the entering measured values and the resulting flow rates and/or water levels. An early and highly resolved high water warning can be implemented for a drainage basin. The measuring system in the case of forecasted exceeding of defined limit values outputs, for example, a corresponding warning signal to competent control stations.

The invention relates to a measuring system and to a corresponding method, by means of which a flow rate and/or a water level are forecastable in a drainage basin (colloquially “watershed”) of a body of water as central factors of a region reaction, in order in the case of high water in this region to be able to issue corresponding warnings.

With increasing intensity of extreme weather events, the warning of high water events in the drainage basins of bodies of water assumes an always more central role. The pure registering of high water events is based according to the state of the art on level measurement at meaningful sites of bodies of water, such as, for example:
at the headwaters of the body of water,
at the mouth of the body of water,
below important inflows accompanied by marked increase of the size of the drainage basin,
at water retention areas, natural and man-made lakes or oceans with water level-dynamic range as well as at their in- and outlets.

In such case, the level can be read visually at structures with corresponding scales. In the case of more modern design, the level can also be measured in automated fashion, for example, by means of radar based level measurement. Radar based measuring devices, by means of which level, e.g. fill level, can be determined, are known, for example, from DE 102020100867 A1.

A possible, locationally resolved analysis of extreme precipitation events is described in DE102020119488 A1. The measuring system there is based on local measurement of precipitation amounts at a plurality of measuring points and following, decentral evaluation based on a self-learning, AI-based algorithm (“Artificial Intelligence”). Advantageous in this is that a very small meshed resolution can be achieved.

The official warning of high water is based mainly on the providing of meteorological data, by means of which the amount of precipitation is forecast as central decision criterion. Based on this, a reliable forecast of the region reaction at a future time period, or a future point in time, in the range of a number of hours to a number of days lead time can be given. In such case, serving as primary physical target variables of a region reaction as a function of time are the water level and the amount of flow at defined target locations, i.e. locations of interest, of the region.

The minimum possible grid, with which a region reaction forecast can be locationally resolved based on purely meteorological data amounts, as a rule, to several hundred meters. In such case, the precipitation amounts can vary locationally greatly exactly in the case of extreme weather events. Moreover, a high water situation possibly resulting therefrom depends on the, in given cases, unknown bodies of water situation in this forecast region, since the precipitation amounts are brought away via the bodies of water and their drainage basins. The region referenced result of a precipitation event is referred to, in such case, as the region reaction, wherein the water level and the flow rate at the considered target location of the grid are the central, physical, measured variables of the region reaction. If the—forecasted—water level and/or flow rate exceed a limit value individually defined for the target location, then this defined as a high water situation. In this connection, not only bodies of water of first order, but also bodes of water of second and third order, and their drainage basins are especially endangered, since it is primarily along these drainage basins that the precipitation amounts are removed.

An object of the invention is to be able to provide a reliable high water warning for at least one defined target location in the drainage basin of a body of water.

The invention achieves this object by a measuring system for forecasting a water level and/or a flow rate for at least one defined target location in a drainage basin of a body of water. In such case, the terminology “forecast” within the scope of the invention means calculating the expected value for a defined point in time, length of time or time period in the future. The measuring system of the invention comprises components as follows:
one or more measuring devices arranged at the target location and/or within the drainage basin of the body of water, in order to determine in the form of a measured value
   a water level
   a soil moisture, such as described, for example, in WO 2019096766 A1, and/or
   a precipitation, for example, an accumulated amount of precipitation or a precipitation intensity,
connected with the at least one measuring device, an evaluation unit, which is designed,
   based on the at least one measured value, as well as
   based on a defined algorithm, which describes a dependence of the flow rate and/or the water level at the target location of the body of water on the at least one measured value,
to forecast the flow rate and/or the water level at the target location for a defined length of time or over a defined time period.

With the measuring system of the invention, in case of doubt, a situation can be analyzed, and, in the case of danger of high water, a warning issued with sufficient lead time. Moreover, the warning can be with locationally very fine resolution. In this way, also possible, locationally greatly limited warning situations can be detected, situations which would not be detected by means of conventional predictions based on purely meteorological data. Especially when the water levels/flow rates and, in given cases, flow directions at individual target locations are forecast by the measuring system covering a defined time period, forecast results for particular points in time can, in given cases, also be correspondingly corrected, i.e. updated.

The measuring system of the invention can be designed especially efficiently when a machine learning algorithm is implemented in the evaluation unit, especially a machine learning algorithm formed as an artificial neural network or a deep learning method. In such case, the algorithm can be trained, or optimized, based especially on continuously measured measured values, and based on a water level measured at least once at the target location and/or a flow rate measured there at least once.

In order that the measuring system of the invention require as little infrastructure as possible, and be installable with as little effort as possible, it is advantageous that the one or more measuring devices be designed energy-autarkically, for example, by equipping them with corresponding buffer batteries. Especially in order that the batteries remain alive as long as possible, the measuring rate of a measuring device or its transmission rate to the evaluation unit can especially be controlled proportionally or stepwise as a function of the measured value or the forecasted flow rate or the forecasted water level. In this way, in case of a possibly arriving high water event, it is assured that the measuring device measures and transmits the measured values sufficiently often, exactly in the case of exceeding of defined limit values. When the measured value of the measuring device, or the corresponding forecasted region reaction (water level/flow rate), does not exceed limit values, the measuring-, and transmission rate can, for example, be correspondingly slowed by the evaluation unit control.

In general, the evaluation unit of the measuring system of the invention can be implemented by means of any suitable digital circuits, such as, for example, FPGAs, microcontrollers or storage media in cooperation with corresponding programs. Preferably, a decentral server can function as evaluation unit, wherein the at least one measuring device is connected with the server via a wireless interface, especially a GSM interface. This assures a fast and secure measured value transmission.

Optionally, moreover, meteorological prediction data for the drainage basin of the body of water can be incorporated for optimizing forecasted water level and/or forecasted flow rate at target locations.

For this, the evaluation unit needs to be correspondingly designed, in order to be able to receive such data. This can occur, in turn, for example, via the GSM interface. The algorithm must, in such case, be correspondingly designed, in order to incorporate the meteorological prediction data into the calculating of the forecasted flow rate and/or the forecasted water level at the target location.

Corresponding to the measuring system of the invention, the object of the invention is achieved by a matching measuring method. In such case, the method serves for forecasting a flow rate and/or a water level at at least one defined target location in a drainage basin of a body of water by means of the measuring system according to one of the above described embodiments. The method comprises method steps as follows:
registering at least
   a water level
   a soil moisture, and/or
   a precipitation
at the target location and/or within the drainage basin of the body of water as the at least one measured value, and
calculating the flow rate forecasted for a defined length of time and/or the water level forecasted for such length of time at the at least one target location at least
   based on the at least one measured value, and
   based on the algorithm.

In such case, the high water warning of the invention can be improved by determining the water level and/or the flow rate not only for one target location, but, instead, for two or more different target locations in the drainage basin. The “virtual” arrangement of the target locations by the algorithm can occur, in such case, in grid form. Especially in the case of a server based design of the evaluation unit, the correspondingly increased calculative effort for implementing a plurality of target locations is not a problem.

The invention will now be explained in greater detail based on the appended drawing, the sole FIGURE of which show as follows:

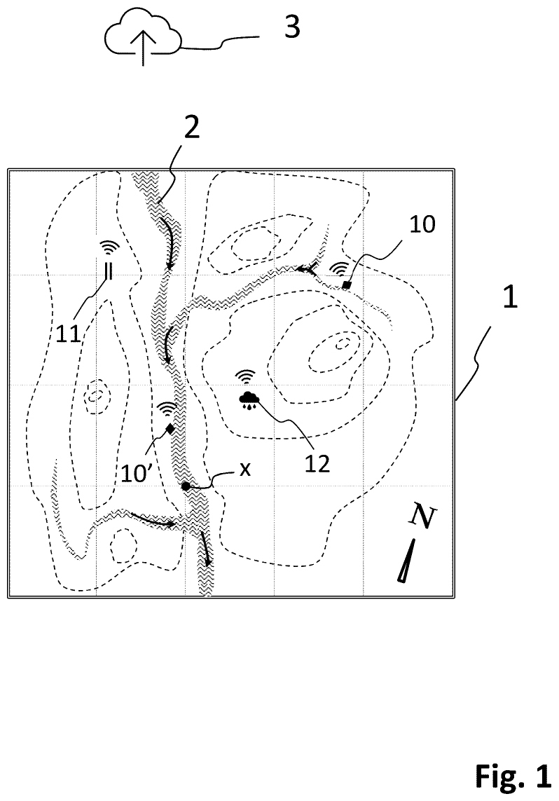

FIG. 1 a schematic view of a drainage basin of a section of a flowing body of water.

For an understanding in principle of the high water forecasting of the invention, FIG. 1 shows schematically a section of a flowing body of water 2, including its drainage basin 1. In such case, the terminology, “drainage basin”, means that region, in which hydrological factors influence the water level and/or the flowed amount of the flowing body of water 2. Counting as factors, accordingly, are, for example, tributaries of the body of water, the topography and the water retention ability of the soil of the region 1. “Bodies of water” include not only flowing bodies of water such as streams and rivers, but, also, for example, temporarily dry streambeds, as well as standing bodies of water, such as lakes and oceans.

For high water monitoring of the drainage basin 1, such can within the scope of the invention be divided into a grid with a mesh size between, for example, 10×10 m and 100×100 m, such as shown schematically in FIG. 1. In such case, each of the grid points forms a potential target location x, which can be taken into consideration for description of a region reaction. This means that a possible water level L, a possible flow rate l/s, and, in given cases, a discharge direction are forecast for each target location x as a function of various input variables.

In the case of the view shown in FIG. 1, for reasons of perspicuity, only one of the grid points is defined as target location x. In contrast with this simplified view, it is probable within the scope of the invention that at least some of the grid arranged target locations x will lie outside of the flowing bodies of water 2. In these cases, thus at such target locations x, the water level L and the flow rate l/s in the absence of a high water situation amount logically to 0 L and 0 L/Sec, respectively. If for one of the target locations x due to a concrete precipitation event a water level L and/or a flow rate l/s is forecast lying above a limit value Lₘₐₓ, l/sₘₐₓ defined individually for such target location, this means a high water warn situation exists.

In order to forecast a region reaction, thus a possible high water situation, as reaction to a precipitation event in the drainage basin 1, there is registered at suitable measuring points as measured value according to the invention at least
the instantaneous water level
the current soil moisture, and/or
a precipitation, such as, for example, the amount of precipitation fallen to the present, or a precipitation intensity

In the case of the schematic view in FIG. 1, a measuring system of the invention includes for registering the corresponding measured values within the drainage basin 1 as measuring device types, consequently,
a water level measuring device 10 at a tributary of the flowing body of water 2,
a water level measuring device 10′ on the main run of the flowing body of water 2 upstream from the target location x,
a moisture measuring device 11 for determining soil moisture, and
a precipitation measuring device 12, which can register at least instantaneous precipitation as a binary event (Yes/No).

In such case, it is clear that the region reaction, thus, the grid density of the target locations x and the there ascertained water levels L, and flow rates l/s, can be forecast with greater detail and safely, the more measuring devices 10, 10′, 11, 12, and measuring device types, applied by the measuring system within the drainage basin 1. In order that the measuring devices 10, 10′, 11, 12 can work autarkically, and wirelessly, it is advantageous to equip them, in each case, at least with a corresponding buffer battery and/or with additional solar cells. Also a possible repositioning of the measuring devices 10, 10′, 11, 12 within the drainage basin 1 is facilitated thereby.

The measured values registered by the measuring devices 10, 10′, 11, 12 are fed to an evaluation unit 3 of the measuring system as input variables of a corresponding algorithm. In such case, the evaluation unit 3 is, corresponding to the embodiment shown in FIG. 1, preferably decentrally implemented and not a component of one of the measuring devices 10, 10′, 11, 12. In this way, in the case of a possible failure of one of the measuring devices 10, 10′, 11, 12, the high water warning is not lost. In the case of the embodiment shown in FIG. 1, the evaluation unit 3 is implemented in the form of a decentral server, which is addressable, for example, via a GSM interface. Correspondingly, also the measuring devices 10, 10′, 11, 12 of the measuring system of the invention have corresponding wireless interfaces, in order to be able to communicate with the server based evaluation unit 3. In this connection, the transmission rate of the measuring devices 10, 10′, 11, 12 to the evaluation unit 3 can be controlled by these as a function of the, in each case, currently measured measured value or as a function of the forecasted region reaction. When the current measured value and/or the forecasted flow rate l/s and/or the forecasted water level L is/are, for example, increased above a defined limit value, also the transmission rate or the measuring rate can be increased. The increase can, in such case, occur stepwise or virtually linearly. Advantageous in this is that the measuring rate and/or the transmission rate of the individual measuring devices 10, 10′, 11, 12 can be set to very low default values, when no warn situation is expected. In this way, the readiness of the autarkically working measuring devices 10, 10′, 11, 12 can be significantly lengthened.

The algorithm implemented in the evaluation unit 3 describes the relationship between
the measured values obtained from the measuring devices 10, 10′, 11, 12, and
the forecasted flow rates l/s and/or water levels L at the target locations x in the drainage basin 1.

In such case, it is clear that, depending on design of the algorithm, not every one of the target locations x needs to be arranged on the grid. Rather, the one or more target locations x can also lie individually distributed as a function of the concrete drainage basin 1. Likewise, it is in the context of the invention, depending on the situation in the concrete drainage basin 1, also an option that at least some of the measuring devices (—types) 10, 10′, 11, 12 be arranged on the grid, or at decided target locations x.

In order that the measuring system of the invention is adaptable to a wide variety of bodies of water 2, and a wide variety of drainage basins 1, the algorithm must incorporate
the topology of the drainage basin 1,
its soil properties, and
the extent of the flowing bodies of water 2, and their tributaries and drains.

An opportunity for taking these into consideration lies in designing the algorithm in the evaluation unit 3 as a maschine learning algorithm. For this, a corresponding artificial neural network can be formed in the evaluation unit 3, for example in the form of “Deep Learning”. Target variables to be optimized here include especially the accuracy and safety of the forecast of the region reaction, thus the forecast-accuracy and the forecast safety of the water levels L and the flow rates l/s at the individual target locations x as well as, in given cases, an optimum resolution or position of the corresponding target locations x.

For such an optimizing, on the one hand, the measured values ascertained by the measuring devices 10, 10′, 11, 12 must be transmitted to the evaluation unit 3, thus to the algorithm, and, indeed, as continuously as possible during at least one defined beginning-learning phase. On the other hand, at least during this learning phase, the corresponding water levels L and flow rates l/s must be given to the evaluation unit 3, thus to the maschine learning algorithm. In such case, it is within the scope of the invention not decisive per se, whether the values L, l/s given to the algorithm come from measurements at corresponding target locations x, or whether suitable literature-, or estimated, values are given. Moreover, it is not decisive, whether the maschine learning algorithm is designed to use “monitored” or “unmonitored” learning. Also the beginning-learning phase does not need to be time limited, so that the algorithm can, instead, be optimized, or adapted, continuously during the total operation of the measuring system.

In contrast with the embodiment shown in FIG. 1, the measuring system of the invention can not only be applied for flowing waters 2, but, instead, also for all other bodies of water, whose drainage basin is high water endangered. On the whole, the high water forecast of the invention by means of the measuring system offers the advantage that, on the one hand, a very timely forecast of the flow rates and water levels can be given. Thus, in case of doubt, a situation can be analyzed, and, in the case of danger of high water, a warning issued with sufficient lead time. On the other hand, the warning can be given with locationally very great resolution. In this way, also possible locationally greatly confined warning situations can be detected, which would not be detected as such by means of conventional predictions based on purely meteorological prediction data. Yet it is an option within the scope of the invention also to incorporate such meteorological prediction data into the forecast water levels/flow rates of the invention, when such is correspondingly transmitted to the evaluation unit 3, or when the implemented algorithm correspondingly incorporates such prediction data. In the case of a self-learning algorithm, such can serve supplementally for an improved fitting of the high water warning to the specific drainage basin (1).

### LIST OF REFERENCE CHARACTERS

1 drainage basin
2 body of water
3 evaluation unit
10, 10′ water level measuring device
11 soil moisture measuring device
12 precipitation measuring device
L water level
l/s flow rate
x target location
1-10. (Canceled)

11. A measuring system for forecasting a water level and/or a flow rate at at least one defined target location in a drainage basin of a body of water, comprising:
at least one measuring device arranged at the target location and/or within the drainage basin of the body of water, in order to determine as measured value at least
a water level
a soil moisture, and/or
an amount of precipitation,
connected with the at least one measuring device, an evaluation unit,
which is designed
based on the at least one measured value, as well as
based on a defined algorithm, which describes a dependence of the flow rate and/or the water level at the target location of the body of water on the at least one measured value,
to forecast the flow rate and/or the water level at the target location at least for a defined length of time.

12. The measuring system as claimed in claim 11, wherein a machine learning algorithm is formed in the evaluation unit in such a manner that the algorithm can be trained
based on measured values measured continuously by the measuring device, and
based on a water level measured at least once at the target location and/or a flow rate measured there at least once

13. The measuring system as claimed in claim 11, wherein the machine learning algorithm is designed as an artificial neural network.

14. The measuring system as claimed in claim 11, wherein the evaluation unit is designed to forecast the flow rate and/or the water level of the body of water over a defined time period.

15. The measuring system as claimed in claim 11, wherein the at least one measurement device is designed to set a measurement rate or a transmission rate to the evaluation unit proportionally or stepwise as a function of
the measured value, or
the forecasted flow rate, or the forecasted water level.

16. The measuring system as claimed in claim 11, wherein the evaluation unit is designed as a decentral server, and wherein the at least one measuring device is connected with the server via a wireless interface.

17. The measuring system as claimed in claim 16, wherein the at least one measuring device is designed energy-autarkically.

18. The measuring system as claimed in claim 11, in the case of which the evaluation unit is designed to receive meteorological prediction data for the drainage basin of the body of water, and
wherein the algorithm is designed to incorporate the meteorological prediction data into the calculating of the forecasted flow rate and/or the forecasted water level at the target location.

19. A method for forecasting a flow rate and/or a water level at at least one defined target location in a drainage basin of a body of water by means of a measuring system, wherein the method comprises method steps as follows:
registering at least
a water level
a soil moisture, and/or
an amount of precipitation
at the target location and/or within the drainage basin of the body of water as the at least one measured value, and
calculating the flow rate forecasted for a defined length of time and/or the water level forecasted for such length of time at the at least one target location at least
based on the at least one measured value, and
based on the algorithm.

20. The method as claimed in claim 19, wherein the water level and/or the flow rate is determined at at least four different target locations in the drainage basin, especially locations arranged in a defined grid relative to one another.
